(19) United States
(12) Patent Application Publication
(10) Pub. No.: US 2014/0006825 A1
(43) Pub. Date: Jan. 2, 2014

(54) SYSTEMS AND METHODS TO WAKE UP A DEVICE FROM A POWER CONSERVATION STATE

(71) Applicant: DAVID SHENHAV, Zichron Yaaqov (IL)

(72) Inventor: DAVID SHENHAV, Zichron Yaaqov (IL)

(21) Appl. No.: 13/539,357

(22) Filed: Jun. 30, 2012

(51) Int. Cl. G06F 1/26

(52) U.S. Cl. 713/323; 713/300

(57) ABSTRACT

Systems and methods for transitioning an electronic device from a power conservation state to a powered state based on detected sounds and an analysis of the detected sound are disclosed.

### FIELD OF DISCLOSURE

The present disclosure relates to devices in power conservation states, and more particularly, to waking up devices from power conservation states.

### BACKGROUND

Despite advancements in functionality and speed, mobile devices still remain largely constrained by finite battery capacity. Given the increased processing speeds of the devices, absent some form of power conservation, the available battery capacity will likely be depleted at a rate that significantly hampers mobile use of the device absent an auxiliary power source. One form of energy conservation to extend battery life is to put one or more elements of a device into a power conservation state, such as a standby mode, when those elements of the device are not actively in use.

Conventional approaches to waking up a mobile device from standby often require a user to touch or physically engage the mobile device in some fashion. Understandably, physically touching an electronic device may not be convenient or desirable under certain circumstances, such as if the user is wet, if the user desires hands-free operation while driving, or if the device is out of reach of the user. Speech recognition technology may be used to wake up one or more elements of a mobile device.

The performance of speech recognition technology has improved with the development of faster processors and improved speech recognition methods. In particular, there have been improvements in the accuracy of speech recognition engines recognizing words. In other words, there have been improvements in accuracy based on metrics for speech recognition, such as word error rates (WER). Despite improvements and advances in the performance of speech recognition technology, the accuracy of speech recognition in certain environments, such as noisy environments, may still be prone to error. Additionally, speech recognition may require a high level of processing bandwidth that may not always be available on a mobile device and especially on a mobile device in a power conservation state.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an illustration of an example distributed network including one or more computing devices, in accordance with embodiments of the disclosure.

FIG. 2 is a schematic illustration of an electronic device, in accordance with embodiments s of the present disclosure.

FIG. 3 illustrates a flow diagram of at least a portion of a method for transmitting a wake-up inquiry, in accordance with embodiments of the disclosure.

FIG. 4 illustrates a flow diagram of at least a portion of a method for waking up the example electronic device of FIG. 2 in response to receiving a wake-up signal, in accordance with embodiments of the disclosure.

FIG. 5 illustrates a flow diagram of at least a portion of a method for transmitting a wake-up signal, in accordance with embodiments of the disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible.

The disclosure will now be described with reference to the drawings, in which like reference numerals refer to like parts throughout. For purposes of clarity in illustrating the characteristics of the present disclosure, proportional relationships of the elements have not necessarily been maintained in the figures.

Embodiments of the disclosure may include an electronic device, such as a mobile device or a communications device that is configured to be in more than one power state, such as an on state or a stand by or low power state. The electronic device may further be configured to detect a sound and generate a sound signal corresponding to the detected sound while in the stand by state. The electronic device may be able to perform initial processing on the sound signal while in the stand by state, and determine if the sound signal may be indicative of one or more particular wake-up phrases. In certain aspects, main and/or platform processors associated with the electronic device may be in a low power or non-processing state. However, other processing resources, such as communication processors and/or modules, may be used to generate the sound signal and process the sound signal to determine an indication of the sound signal matching a wake-up phrase. If the electronic device determines a relatively high and/or a high enough likelihood that the sound signal may be representative of a wake-up phrase, then the electronic device may transmit the sound signal to a remote server, such as a recognition server, to further analyze the sound signal and determine of whether the sound signal is indeed representative of a wake-up phrase. In one aspect, the sound signal may be transmitted to a recognition server for verification of whether it is representative of one or more wake-up phrases as part of a wake-up inquiry request.

In further embodiments, the recognition server may receive the wake-up inquiry request from the electronic device and extract the sound signal therefrom. The recognition server may then analyze the sound signal using speech and/or voice recognition methods to determine if the sound signal is indicative of one or more wake-up phrases. If the sound signal is indicative of one or more wake-up phrases, then the recognition server may generate and transmit a wake-up signal to the electronic device. The wake-up signal may prompt the electronic device to wake up from a sleep or stand by state to a powered state.

Therefore, it may be appreciated that, in certain embodiments, one or more relatively lower bandwidth processors of the electronic device may initially determine if a detected sound may be indicative of a wake-up phrase while higher bandwidth processors of the electronic device may be in a stand by mode. In one aspect, the wake-up phrase may be uttered by the user of the electronic device. If it is determined that the sound may be indicative of one or more wake-up phrases, then the electronic device may transmit a signal representative of the sound to the recognition server for further verification of whether the sound is indeed representative of one or more wake-up phrases. The recognition server may conduct this verification using computing and analysis resources, which in certain embodiments, may exceed the computing bandwidth of the relatively lower bandwidth processors of the electronic device. If the recognition server determines that the sound is a match to one or more wake-up phrases, then the recognition server may transmit a wake-up signal to the electronic device to prompt the electronic device to wake up from the stand-by state.

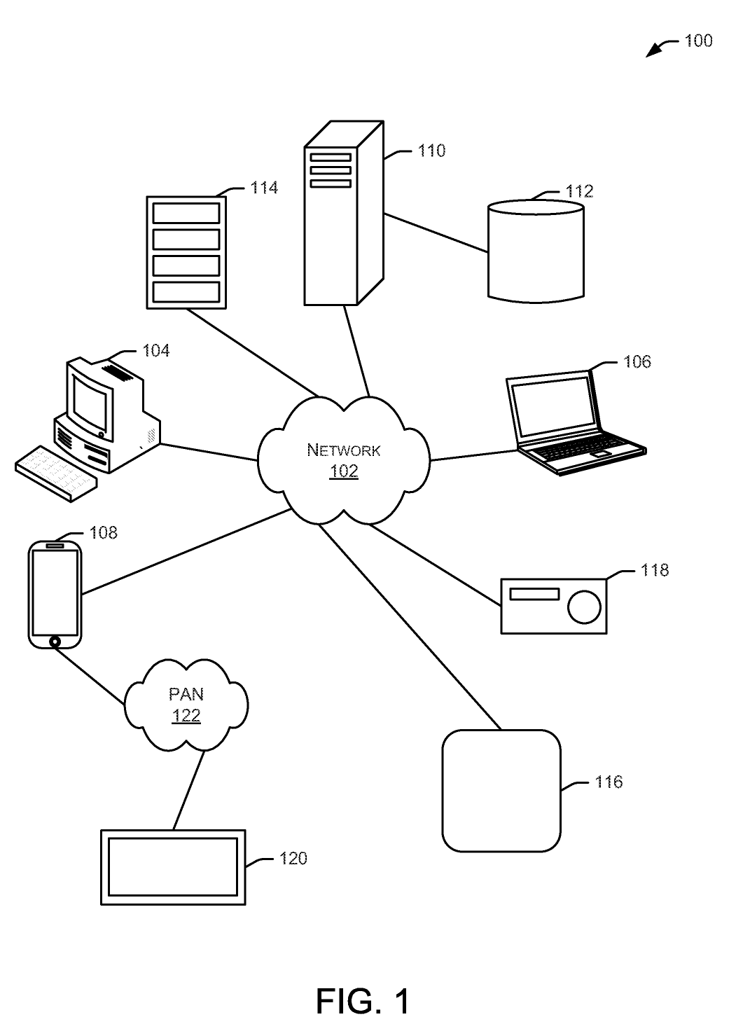

FIG. 1 is an illustration of an example distributed network 100, including one or more mobile devices, in which embodiments according to the present system and method of the disclosure may be practiced. Distributed network 100 may be implemented as any suitable communications network including, for example, an intranet, a local area network (LAN), a wide area network (WAN) such as the Internet, wireless networks, public service telephone networks (PSTN), or any other medium capable of transmitting or receiving digital information. The distributed network environment 100 may include a network infrastructure 102. The network infrastructure 102 may include the medium used to provide communications links between network-connected devices and may include switches, routers, hubs, wired connections, wireless communication links, fiber optics, and the like.

Devices connected to the network 102 may include any variety of mobile and/or stationary electronic devices, including, for example, desktop computer 104, portable notebook computer 106, smartphone 108, and server 110 with attached storage repository 112. Additionally, network 102 may further include network attached storage (NAS) 114, a digital video recorder (DVR) 116, and a video game console 118. It will be appreciated that one or more of the devices connected to the network 102 may also contain processor(s) and/or memory for data storage.

As shown, the smartphone 108 may be linked to a global positioning system (GPS) navigation unit 120 via a Personal Area Network (PAN) 122. Personal area networks 122 may be established a number of ways including via cables (generally USB and/or Fire Wire), wirelessly, or some combination of the two. Compatible wireless connection types include Bluetooth, infrared, Near Field Communication (NFC), ZigBee, and the like.

A person having ordinary skill in the art will appreciate that a PAN 122 is typically a short-range communication network among computerized devices such as mobile telephones, fax machines, and digital media adapters. Other uses may include connecting devices to transfer files including email and calendar appointments, digital photos and music. While the physical span of a PAN 122 may extend only a few yards, this type of connection can be used to share resources between devices such as sharing the Internet connection of the smartphone 108 with the GPS navigation unit 120 as may be desired to obtain live traffic information. Additionally, it is contemplated by the disclosure that a PAN 122 or similar connection type may be used to share additional resources such as GPS navigation unit 120 application level functions, text-to-speech (TTS) and voice recognition functionality, with the smartphone 108.

Certain aspects of the present disclosure relate to software as a service (SaaS) and cloud computing. One of ordinary skill in the art will appreciate that cloud computing relies on sharing remote processing and data resources to achieve coherence and economies of scale for providing services over distributed networks 100, such as the Internet. Processor intensive operations may be pushed from a lower power device, such as a smartphone 108, to be performed by one or more remote devices with higher processing power, such as the server 110, the desktop computer 104, the video game console 118 such as the XBOX 360 from Microsoft Corp, or PlayStation 3 from Sony Computer Entertainment America LLC. Therefore, devices with relatively lower processing bandwidth may be configured to transfer processing tasks requiring relatively high levels of processing bandwidth to other processing elements on the distributed network 100. In one aspect, devices on the distributed network 100 may transfer processing intensive tasks, such as speech and/or sound recognition.

Cloud computing, in certain aspects, may allow for the moving of applications, services and data from local devices to one or more remote servers where functions and/or processing are implemented as a service. By relocating the execution of applications, deployment of services, and storage of data, cloud computing offers a systematic way to manage costs of open systems, to centralize information, to enhance robustness, and to reduce energy costs including depletion of mobile battery capacity.

A “client” may be broadly construed to mean any device connected to a network 102, or any device used to request or get a information. The client may include a browser such as a web browser like Firefox, Chrome, Safari, or Internet Explorer. The client browser may further include XML compatibility and support for application plug-ins or helper applications. The term “server” should be broadly construed to mean a computer, a computer platform, an adjunct to a computer or platform, or any component thereof used to send a document or a file to a client.

One of skill in the art will appreciate that according to some embodiments of the present disclosure, server 110 may include various capabilities and provide functions including that of a web server, E-mail hosting, application hosting, and database hosting, some or all of which may be implemented in various ways, including as three separate processes running on multiple server computer systems, as processes or threads running on a single computer system, as processes running in virtual machines, and as multiple distributed processes running on multiple computer systems distributed throughout the network.

The term “computer” should be broadly construed to mean a programmable machine that receives input, stores and manipulates data, and provides output in a useful format. “Smartphone” 108 should be broadly construed to include information appliances, tablet devices, handheld devices and any programmable machine that receives input, stores and manipulates data, and provides output in a useful format such as an iOS based mobile device from Apple, Inc. or a device operating on a carrier-specific version of the Android OS from Google. Other examples include devices running WebOS from HP, Blackberry from RIM, Windows Mobile from Microsoft, Inc., and the like. Smartphone 108 may include complete operating system software providing a platform for application developers and may include features such as a camera, an infrared transceiver, an RFID transceiver, or other multiple types of connected and wireless functionality.

Those of ordinary skill in the art will appreciate that the hardware depicted in FIG. 1 may vary depending on the implementation of an embodiment in the present disclosure. Other devices may be used in addition to, or in place of, the hardware depicted. The depicted example is not meant to imply architectural limitations with respect to the present disclosure.

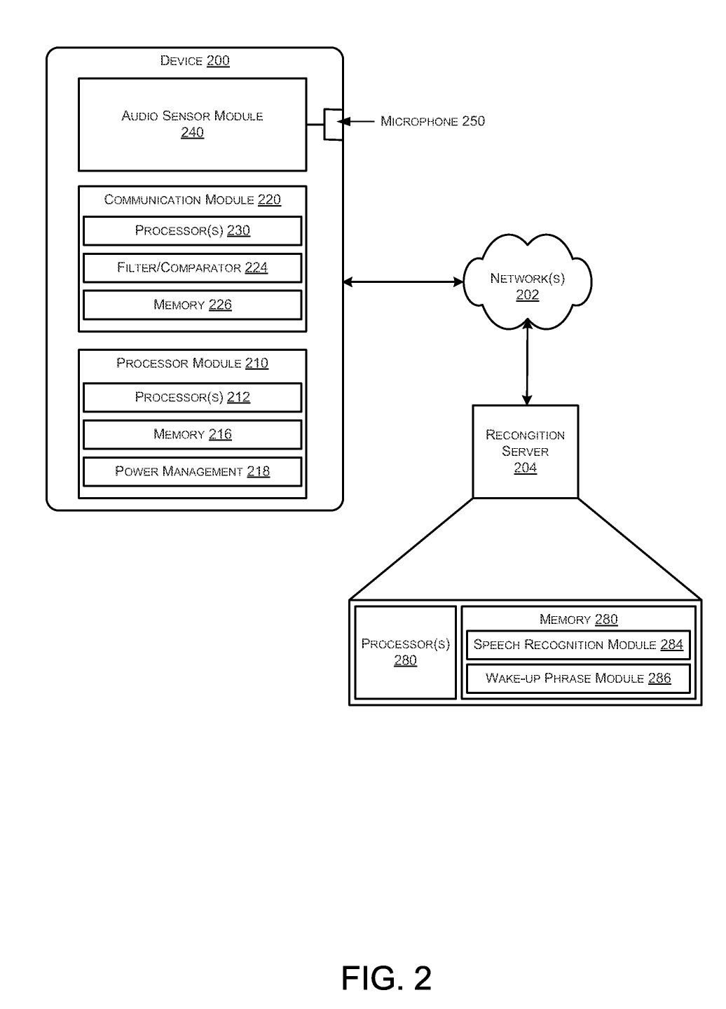

Turning to FIG. 2, a schematic view of an example mobile device 200 according to embodiments of the disclosure is shown. The mobile device 200 may be in communication with a network 202 and a recognition server 204. While the mobile device 200 is generally depicted in FIG. 2 as a smartphone/tablet, it will be appreciated that device 200 may represent any variety of suitable mobile devices, including one or more of the devices shown in FIG. 1. Furthermore, while the disclosure herein may be described primarily in the context of a mobile electronic device, it will be appreciated that the systems and methods described herein may apply to any suitable type of electronic devices, including stationary electronic devices.

As shown, device 200 may include a platform processor module 210 which may perform processing functions for the mobile device 200. Examples of the platform processor module 210 may be found in any number of mobile devices and/or communications devices having one or more power saving modes, such as mobile phones, computers, car entertainment devices, and personal entertainment devices. According to one embodiment of the disclosure, the processor module 210 may be implemented as a system on chip (SoC) and/or a system on package (SoP). The processor module 210 may also be referred to as the processor platform. The processor module 210 may include one or more processor(s) 212, one or more memories 216, and power management module 218.

The processors) 212 may include, without limitation, a central processing unit (CPU), a digital signal processor (DSP), a reduced instruction set computer (RISC), a complex instruction set computer (CISC), or any combination thereof. The mobile device 200 may also include a chipset (not shown) for controlling communications between the processor(s) 212 and one or more of the other components of the mobile device 200. In one embodiment, the mobile device 200 may be based on an Intel® Architecture system, and the processors) 212 and the chipset may be from a family of Intel® processors and chipsets, such as the Intel® Atom® processor family. The processors) 212 may also include one or more processors as part of one or more application-specific integrated circuits (ASICs) or application-specific standard products (ASSPs) for handling specific data processing functions or tasks.

The memory 216 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 216 of the processor module 210 may have instructions, applications, and/or software stored thereon that may be executed by the processors 212 to enable the processors to carry out a variety of functionality associated with the mobile device 200. This functionality may include, in certain embodiments, a variety of services, such as communications, navigation, financial, computation, media, entertainment, or the like. As a non-limiting example, the processor module 210 may provide the primary processing capability on a mobile device 200, such as a smartphone. In that case, the processor module 210 and associated processors 212 may be configured to execute a variety of applications and/or programs that may be stored on the memory 216 of the mobile device 200. Therefore, the processors 212 may be configured to run an operating system, such as Windows® Mobile®, Google® Android®, Apple® iOS®, or the like. The processors 212 may further be configured to am a variety of applications that may interact with the operating system and provide services to the user of the mobile device 200.

In certain embodiments, the processors 212 may provide a relatively high level of processing bandwidth on the mobile device 200. In the same or other embodiments, the processors 212 may provide the highest level of processing bandwidth and/or capability of all of the elements of the mobile device 200. In one aspect, the processors 212 may be capable of running speech recognition algorithms to provide a relatively low real time factor (RTF) and a relatively low word error rate (WER). In other words, the processors 212 may be capable of providing speech recognition with relatively low levels of latency observed by the user of the mobile device 200 and relatively high levels of accuracy. Additionally, in these or other embodiments, the processors 212 may consume a relatively high level of power and/or energy during operation. In certain cases of these embodiments, the processors 212 may consume the most power of all of the elements of the mobile device 200.

The power management module 218 of the processor module 210 may be, in certain embodiments, configured to monitor the usage of the mobile device 200 and/or the processor module 210. The power management module 218 may further be configured to change the power state of the processor module 210 and/or the processors 212. For example, the power management module 218 may be configured to change the processor 212 state from an “on” and/or fully powered state to a “stand by” and/or partially or low power state. In one aspect, the power management module 218 may change the power state of the processors 212 from the powered state to stand by if the processors 212 are monitored to use relatively low levels of processing bandwidth for a predetermined period of time. In another case, the power management module 218 may place the processors 212 in a stand by mode if user interaction with the mobile device 200 is not detected for a predetermined span of time. Indeed, the power management module 218 may be configured to transmit a signal to the processors 212 and/or other elements of the processor module 210 to power down and/or “go to sleep.”

The power management module 218 may further be configured to receive a signal to indicate that the processor module 210 and/or processors 212 should “wake up.” In other words, the power management module 218 may receive a signal to wake up the processors 212 and responsive to the wake-up signal, may be configured to power up the processors 212 and/or transition the processors 212 from a standby mode to an on mode. Therefore, an entity that may desire to wake up the processors 212 may provide the power management module 218 with a wake-up signal. It will be appreciated that the power management module 218 may be implemented in hardware, software, or a combination thereof.

The mobile device 200 may further include a communications module 220 which may include a filter/comparator module 224, memory 226, and one or more communications processors 230. The communications module 220, the filter/comparator module 224, and the processors 230 may be configured to perform several functions of the mobile device 200, such as processing communications signals. For example, the communications module may be configured to receive, transmit, and/or encrypt/decrypt Wi-Fi signals and the like. The communications module 220 and the communications processors 230 may further be configured to communicate with the processor module 210 and the associated processors 212. Therefore, the communications module 220 and the processor module 210 may be configured to cooperate for a variety of services, such as, for example, receiving and/or transmitting communications with entities external to the mobile device 200, such as over the network 202. Furthermore, the communications module 220 may be configured to receive and/or transmit instructions, applications, program code, parameters, and/or data to/from the processor module 210. As a non-limiting example, the communications module 220 may be configured to receive instructions and/or code from the processor module 210 prior to when the processor module 210 transitions to a stand by mode. In one aspect, the instructions may be stored on the memory 226. As another non-limiting example, the communications module 220 may be configured to transfer instructions and/or code to the processor module 210 after the processor module 210 wakes up from a stand by mode. In one aspect, the instructions may be accessed from the memory 226.

The filter/comparator module 224 and/or the communications processors 230 may, in one aspect, provide the communications module 220 with processing capability. According to aspects of the disclosure, the communications module 220, the filter/comparator module 224, and the processor 230 may perform alternate functions when the processor module 210 is turned off, powered down, in an energy conservation mode, and/or is in a standby mode. For example, when the processor module 210 is in a standby mode, or when it is completely turned off, the communications module 220 may switch to a set of low power functions, such as functions where the communications module 220 may continually monitor for receipt of communications data, such as a sound indicative of waking up the mobile device 200 along with any components, such as the processor module that may be in a power conservation mode. The communications module 220, filter/comparator module 224, and the processor 230 may, therefore, be configured to receive a signal associated with a sound and process the received signal. In one aspect, the communications processors 230 and or the filter/comparator module 224 may be configured to determine if the received signal associated with the sound is indicative of a probability greater than a predetermined probability level that the sound matches a wake-up phrase.

The communications module 220 may further be configured to transmit the signal associated with the sound to the recognition server 204 via network 202. In one aspect, the communications module 220 may be configured to transmit the signal associated with the sound if the communications module 220 determines that the sound is potentially the wake-up phrase. Therefore, the communications module 220 may be configured to receive a signal representative of a sound, process the signal, determine, based at least in part on the signal if the sound if likely to match a predetermined wake-up phrase, and if the probability of a match is greater than a predetermined probability threshold level, then transmit the signal representative of the sound to the recognition server 204. Therefore, the communications module 220 may be able to make an initial assessment of whether the sound of the wake-up phrase was received, and if there is some likelihood that the received sound is the wake-up phrase, then the communications module may transmit the signal associated with the sound to the recognition server 204 to further analyze and determine with a relatively higher level of probability whether the received sound matches the wake-up phrase. In one aspect, the communications module 220 may be configured to analyze the signal representing the sound while processor module 210 and/or processors 212 are in a sleep mode or a stand by mode.

The probability of a match may be determined by the communications module 220 using any variety of suitable algorithms to analyze the signal associated with the sound. Such analysis may include, but is not limited to, temporal analysis, spectral analysis, analysis of amplitude, phase, frequency, fiber, tempo, inflection, and/or other aspects of the sound associated with the sound signal. In other words, a variety of methods may be used in either the time domain or the frequency domain to compare the temporal and/or spectral representation of the received sound to the temporal and/or spectral representation of the predetermined wake-up phrase. In some cases, there may be more than one wake-up phrase associated with the mobile device 200 and accordingly, the communications module 220 may be configured to compare the signal associated with the sound to more than one signal representation of the wake-up phrase sounds.

The communications module 220, and the associated processing elements, may be further configured to receive a wake-up signal from the recognition server 204 via the network 202. The wake-up signal and/or a signal indicative of the processors 212 waking up may be received by the communications processors 230 and then communicated by the communications processors 230 to the power management module 218. In certain embodiments, the communications processors 230 may receive a first wake-up signal from the recognition server 204 via the network 202 and may generate a second wake-up signal based at least in part on the first wake-up signal. The communications processors 230 may further communicate the second wake-up signal to the processor module 210 and/or the power management module 218.

The mobile device 200 may further include an audio sensor module 240 coupled to one or more microphones. It will be appreciated that according to some embodiments of the disclosure, the audio sensor module 240 may include a variety of elements, such as an analog-to-digital converter (ADC) for converting an audio input to a digital signal, an anti-aliasing filter, and/or a variety of noise reducing or noise cancellation filters. More broadly, it will be appreciated by a person having ordinary skill in the art that while the audio sensor module 240 is labeled as an audio sensor, aspects of the present disclosure may be performed via any number of embedded sensors including accelerometers, digital compasses, gyroscopes, GPS, microphone, cameras, as well as ambient light, proximity, optical, magnetic, and thermal sensors. The microphones 250 may be of any known type including, but not limited to, a condenser microphones, dynamic microphones, capacitance diaphragm microphones, piezoelectric microphones, optical pickup microphones, or combinations thereof. Furthermore, the microphones 250 may be of any directionality and sensitivity. For example, the microphones 250 may be omni-directional, uni-directional, cardioid, or bi-directional. It should also be noted that the microphones 250 may be of the same variety or of a mixed variety. For example, some of the microphones 250 may be condenser microphones and others may be dynamic microphones.

Communications module 220, in combination with the audio sensor module 240, may include functionality to apply at least one threshold filter to audio and/or sound inputs received by microphones 250 and the audio sensor module 240 using low level, out-of-band processing power resident in the communications module 220 to make an initial determination of whether or not a wake-up trigger has occurred. In one aspect, the communications module 220 may implement a speech recognition engine that interprets the acoustic signals from the one or more microphones 250 and interprets the signals as words by applying known algorithms or models, such as Hidden Markov Models (HMM).

The recognition server 204 may be any variety of computing element, such as a multi-element rack server or servers located in one or more data centers, accessible via the network 202. It will also be appreciated that according to some aspects of the disclosure, the recognition server 204 may physically be one or more of the devices attached to the network 102 as shown in FIG. 1. For example, as noted previously, the GPS navigation unit 120 may include TTS (text to speech) and voice recognition functionality. Accordingly, the role of the recognition server 204 may be fulfilled by GPS the navigation unit 120, where sound inputs from the mobile device 200 may be processed. Therefore, signals representing received sounds may be sent to GPS navigation unit 120 for processing using voice/speech recognition functionality built into the GPS navigation unit 120.

The recognition server 204 may include one or more processor(s) 260 and memory 280. The contents of the memory 280 may further include a speech recognition module 284 and a wake-up phrase module 286. Each of the modules 284, 286 may have stored thereon instructions, computer code, applications, firmware, software, parameter settings, data, and/or statistics. The processors 260 may be configured to execute instructions and/or computer code stored in the memory 280 and the associated modules. Each of the modules and/or software may provide functionality for the recognition server 204, when executed by the processors 260. The modules and/or the software may or may not correspond to physical locations and/or addresses in the memory 280. In other words, the contents of each of the modules 284, 286 may not be segregated from each other and may, in fact, be stored in at least partially interleaved positions on the memory 280.

The speech recognition module 284 may have instructions stored thereon that may be executed by the processors 260 to perform speech and/or voice recognition on any received audio signal from the mobile device 200. In one aspect, the processors 260 may be configured to perform speech recognition with a relatively low level of real time factor (RTF), with a relatively low level of word error rate (WER) and, more particularly, with a relatively low level of single word error rates (SWER). Therefore, the processors 260 may have a relatively high level of processing bandwidth and/or capability, especially compared to the communications processors 230 and/or the filter/comparator module 224 of the communications module 220 of the mobile device 200. Therefore, the speech recognition module 284 may configure the processors 260 to receive the audio signal from the communications module 220 and determine if the received audio signal matches one or more wake-up phrases. In one aspect, if the recognition server 204 and the associated processors 260 detect one of the wake-up phrases, then the recognition server 204 may transmit a wake-up signal to the mobile device 200 via the network 202. Therefore, the recognition server 204, by executing instructions stored in the speech recognition module 284, may use its relatively high levels of processing bandwidth to make a relatively quick and relatively error free assessment of whether a sound detected by the mobile device 200 matches a wake-up phrase and, based on that determination, may send a wake-up signal to the mobile device 200.

The wake-up phrase and the associated temporal and/or spectral signal representations of those wake-up phrases may be stored in the wake-up phrase module 286. In some embodiments, the wake-up phrases may have stored therein parameters related to the wake-up phrases. The signal representations and/or signal parameters may be used by the processors 260 to make comparisons between received audio signals and known signal representations of the wake-up phrases, to determine if there is a match. These wake-up phrases may be, for example, “wake up,” “awake,” “phone,” or the like. In some cases, the wake-up phrases may be fixed for all mobile devices 200 that may communicate with the recognition server 204. In other cases, the wake-up phrases may be customizable. In some cases, users of the mobile devices 200 may set a phrase of their choice as a wake-up phrase. For example, a user may pick a phrase such as “do my bidding,” as the wake-up phrase to bring the mobile device 200 and, more particularly, the processors 212 out of a stand by mode and into an active mode. In this case, the user may establish this wake-up phrase on the mobile device 200, and the mobile device may further send a signal representation of this wake-up phrase to the recognition server 204. The recognition server 204 and associated processors 260 may receive the signal representation of the custom wake-up phrase from the mobile device 200 and may store the signal representation of the custom wake-up phrase in the wake-up phrase module 286 of the memory 280. This signal representation of the wake-up phrase may be used in the future to determine if the user of the mobile device 200 has uttered the wake-up phrase. In other words, the signal representation of the custom wake-up phrase may he used by the recognition server 204 for comparison purposes when determining if the wake-up phrase has been spoken by the user of the mobile device 200.

Therefore, initial and subsequent wake-up confirmations may be carried out using out-of-band processing (previously unused, or underused) in the communications module 220 and/or the audio sensor module 240. It will be appreciated that the processing methods described herein take place below application-level processing and may not invoke the processor 210 until a wake-up signal has been confirmed via receipt of a wake-up confirmation message from the recognition server 204.

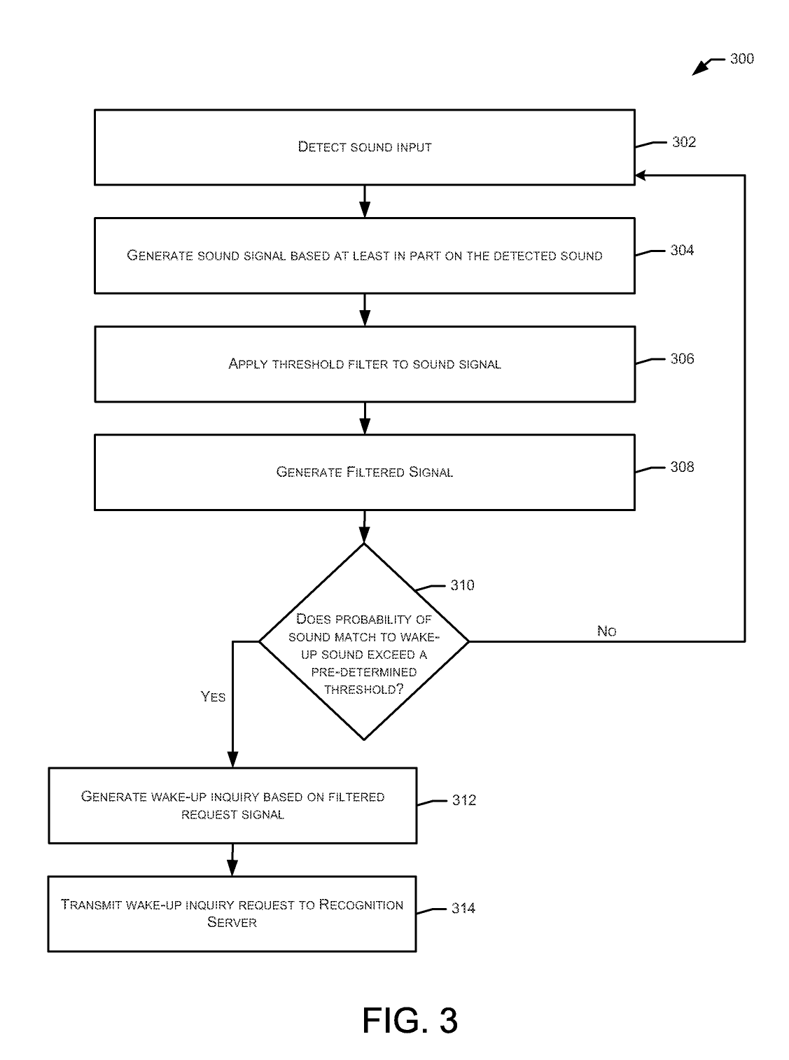

FIG. 3 illustrates an example flow diagram of at least a portion of an example method 300 for transmitting a wake-up inquiry, in accordance with one or more embodiments of the disclosure. Method 300 is illustrated in block form and may be performed by the various elements of the mobile device 200, including the various elements 224, 226, and 230 of the communications module 220. At block 302, a sound input may be detected. The sound may be detected, for example, by the one or more microphones 250 of the mobile device 200. At block 304, a sound signal may be generated based at least in part on the detected sound. In one aspect, the sound signal may be generated by the microphones 250 in analog form and then sampled to generate a digital representation of the sound. The sound may be filtered using audio filters, band pass filters, low pass filters, high pass filters, anti-aliasing filters or the like. According to an embodiment of the present disclosure, the processes of blocks 302 and 304 may be both performed by the audio sensor module 240 and the one or more microphones 250 shown in FIG. 2.

Turning to block 306, a threshold filter may be applied to the sound signal and at block 308, a filtered signal may be generated. In accordance with embodiments of the disclosure, the communications module 220 of FIG. 2 may be used to perform both the steps of applying a threshold filter to the sound signal and generating a filtered signal at blocks 306 and 308. More particularly, the communications module 220 and the associated communications processors 230 may, in some power modes, allow the communications module 220 to be used as a filter/comparator module 224, for performing the step of applying a threshold filter to the sound signal and generating a filtered signal.

An example of generating a filtered sound may include processing the sound input to only include those portions of the sound input that match audio frequencies associated with human speech. Additional filtering may include normalizing sound volume, trimming the length of the sound input, removing background noise, spectral equalization, or the like. It should be noted that the filtering of the signal may be optional and that in certain embodiments of method 300 the sound signal may not be filtered.

At block 310, a determination may be made as to whether or not the filtered signal passes a threshold. This may be a threshold probability that there is a match of the sound to a wake-up phrase. This process may be performed by the communications processors 230 and/or the filter/comparator module 224.

If at block 310, the filtered signal representing the detected sound is found to not exceed a threshold probability of a match to a wake-up phrase, then the method 300 may return to block 302 to detect the next sound input. If however, at block 310 the detected sound is found to exceed a threshold probability of a match to a wake-up phrase, then at block 312, the filtered signal may be encoded into a wake-up inquiry request. In one aspect, the wake-up inquiry request may be in the form of one or more data packets. In certain embodiments, the wake-up inquiry may include an identifier of the mobile device 200 from which the wake-up inquiry request is generated. At block 314, the wake-up inquiry request may be transmitted to the recognition server 204. The steps set forth in blocks 312 and 314 may be performed by the communications module 220 as shown in FIG. 2.

It should be noted that the method 300 may be modified in various ways in accordance with certain embodiments of the disclosure. For example, one or more operations of the method 300 may be eliminated or executed out of order in other embodiments of the disclosure. Additionally, other operations may be added to the method 300 in accordance with other embodiments of the disclosure.

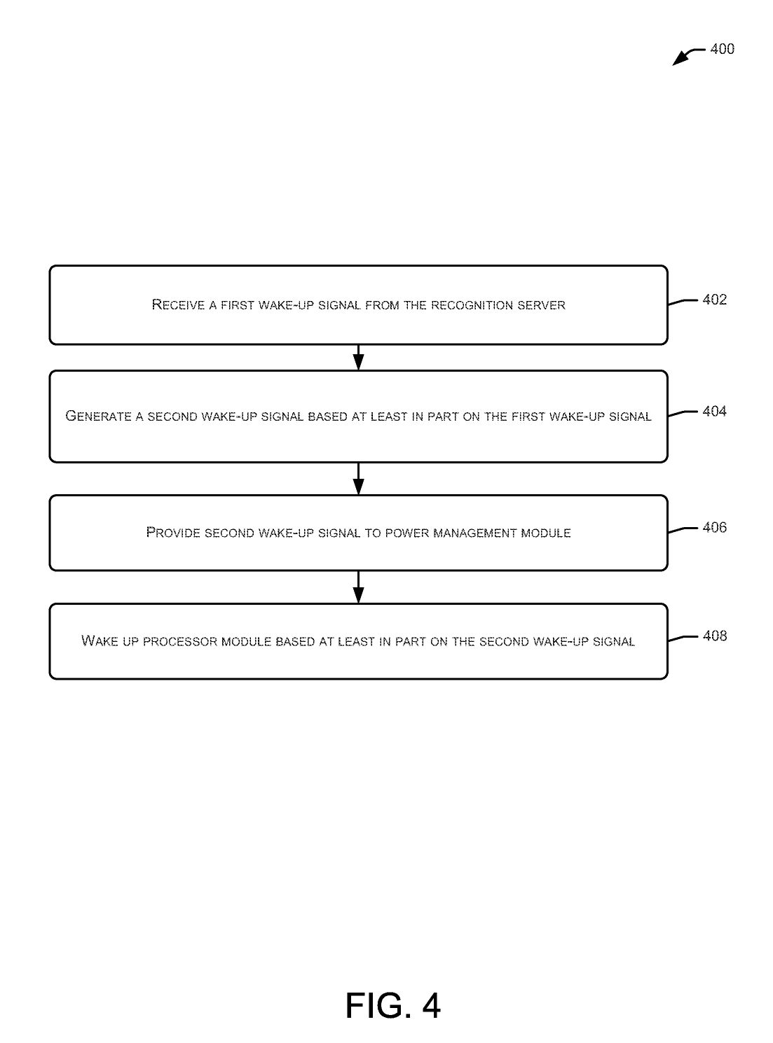

FIG. 4 illustrates a flow diagram of at least a portion of a method 400 for activating the processors 112 responsive to receiving a wake-up signal, in accordance with embodiments of the disclosure. Method 400 may be performed by the mobile device 200 and more specifically, the communications processors 230 and/or the power management module 218. At block 402, a first wake-up signal may be received from the recognition server 204. This wake-up signal may be responsive to the recognition server 204 receiving the wake-up inquiry request, as described in method 300 of FIG. 3. In one aspect, if the recognition server 204 determines that the sound signal received as part of the wake-up inquiry request matches a wake-up phrase, then the recognition server 204 may transmit the first wake-up signal and the same may be received by the mobile device 200.

At optional block 404, a second wake-up signal may be generated based at least in part on the first wake-up signal. This process may be performed by the communications processors 230 for the purposes of providing an appropriate wake-up signal to turn on or change the power state of the processors 212. This process at block 404 may be optional because, in some embodiments, the wake up signal provided by the recognition server 204 may be used directly for waking up the processors 212. Therefore, in those embodiments, the communications processors 230 may not need to translate the wake-up signal received from the recognition server 204.

At block 406, the second wake-up signal may be provided to the power management module. This process may be performed via a communication between the communications processors 230 and the power management module 218 of the processor module 210. At block 408, the processor module 210 may wake up based at least in part on the second wake-up signal.

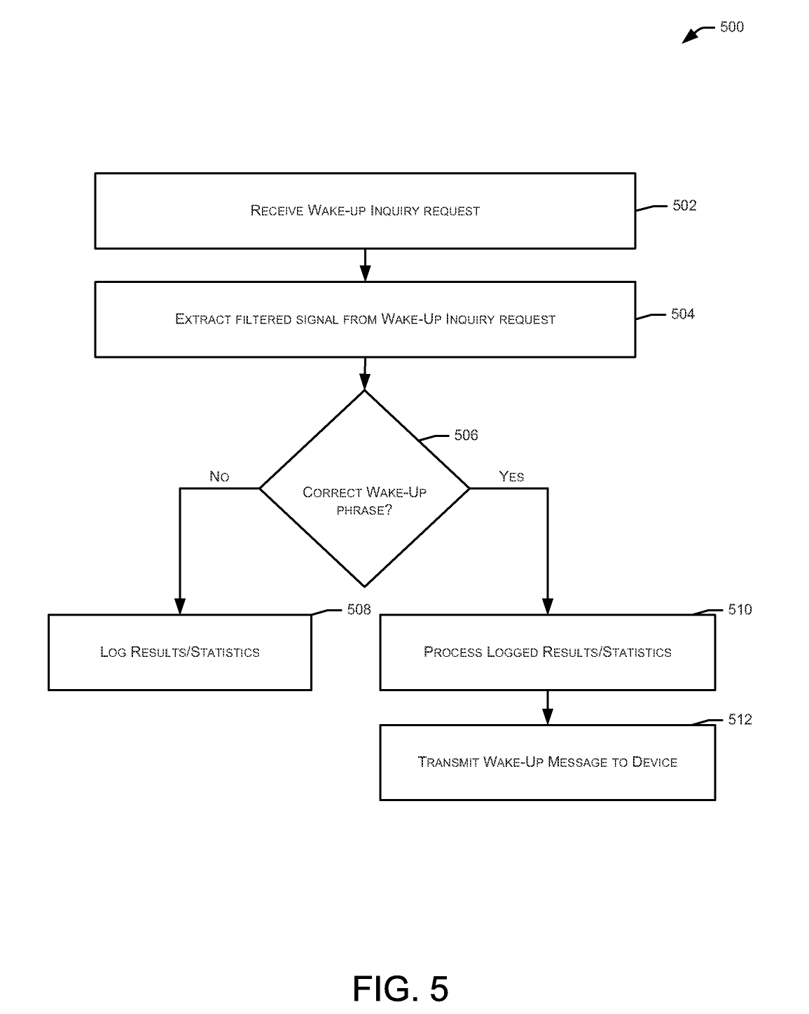

FIG. 5 illustrates a flow diagram of at least a portion of a method 500 for providing a wake-up signal to the mobile device 200 in accordance with embodiments of the disclosure. Method 500 may be executed by the recognition server 204 as illustrated in FIG. 2. Beginning with block 502, the wake-up inquiry request may be received.

Recognition server 204, at block 504, may extract the wake-up sound signal from the wake-up inquiry request by processing the contents of the request. In one aspect, the processors 260 may parse the one or more data packets of the wake-up inquiry request and extract the sound signal and/or the filtered sound signal therefrom. In certain embodiments, the recognition server 204 and the processors 260 thereon, may also extract information pertaining to the identification of the wake-up inquiry request for the mobile device 200.

At block 506, it may be determined if the sound signal corresponds to a correct wake-up phrase. It will be appreciated that unlike the mobile device 200, especially when in a power conservation mode, the recognition server 204 is not restricted to low level, out-of-band, processing. As such, the recognition server 204 may use any number of higher processing bandwidth and/or techniques to analyze and test the sound signal and/or filtered sound signal to make an accurate determination of whether or not a wake-up phrase/trigger is present. By way of example, for an audio trigger/phrase, the recognition server 204 may consider tests including voice recognition, sound frequency analysis, sound amplitude/volume, duration, tempo, and the like. Methods of voice and/or speech recognition are well-known and in the interest of brevity will not be reviewed here.

At block 506, if the correct wake-up phrase is not detected in the wake-up inquiry request, then at optional block 508, the recognition server 204 and associated processors 260 may log the results/message statistics of the inquiry. The results and/or statistics may be kept for any variety of purposes, such as to improve the speech recognition and determination performance of the recognition server 204, for billing and payment purposes, or for the purposes of determining if additional recognition server 204 computational capacity is required during particular times of the day. At this point, no further action is taken by the recognition server 204, until another wake-up inquiry request is received in block 502.

If at block 506, it is determined that the received sound signal does correspond to a wake-up phrase, then the recognition server 204 may, at block 510, may process the logged results and/or statistics of the wake-up recognition. The method 500 may proceed to transmit a wake-up signal to the mobile device 200 at block 512. The wake-up signal, as described above, may enable the processors 212 to awake into an on state from a stand by state.

According to some embodiments of the disclosure, the recognition server 204 may send a version of the results/statistics log to the mobile device 200. In one example, a copy of the log may be sent to the device each time a wake-up signal is sent to the mobile device 200. The copy of the log may include an analysis of the number of wake-up inquiry requests received from the mobile device 200, including, for example, statistics on requests that did not include the correct wake-up phrase. It will be appreciated that some embodiments of the disclosure may use the log analysis on the mobile device 200 to adjust one or more parameters of the threshold filter implemented by the communications module 220 to increase the accuracy of the mobile device 200 processes, and thereby, adjusting the number of wake-up inquiry requests sent to the recognition server 204.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical implementations, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic device comprising:
a sensor configured to detect a sound and generate a sound signal corresponding to the sound;
a communications module configured to determine that the sound signal is indicative of a wake-up phrase to a predetermined probability threshold level, and further configured to transmit a wake-up inquiry request based at least in part on the determining, and to receive a wake-up signal in response to the wake-up inquiry request; and
a platform module configured to transition from a first power state to a second power state based at least in part on the received wake-up signal.

2. The electronic device of claim 1, wherein the communications module is further configured to perform sampling of the sound signal.

3. The electronic device of claim 1, wherein the communications module further includes one or more communication processors configured to generate a filtered sound signal corresponding to the sound signal.

4. The electronic device of claim 3, wherein generating the filtered sound signal comprises at least one of: (i) low pass filtering the sound signal; (ii) high pass filtering the sound signal; (iii) band pass filtering of the sound signal; (iv) anti-alias filtering of the sound signal; or (v) spectral equalization of the sound signal.

5. The electronic device of claim 1, wherein the sensor comprises an audio sensor or a microphone.

6. The electronic device of claim 1, wherein the communications module is further configured to generate the wake-up inquiry request.

7. The electronic device of claim 1, further comprising a filter configured to process the sound signal and determine that the sound signal is indicative of a wake-up phrase to a predetermined probability threshold level.

8. The electronic device of claim 1, wherein determining that the sound signal is indicative of a wake-up phrase to a predetermined probability threshold level further comprises at least one of: (i) spectral analysis of the sound signal; (ii) temporal analysis of the sound signal; (ii) analysis of audio parameters associated with the sound signal.

9. The electronic device of claim 1 where the wake-up inquiry request comprises at least one of: the sound signal or an identification of the electronic device.

10. The electronic device of claim 1, wherein the wake-up signal is received from a recognition server.

11. A method of waking an electronic device from a power conservation mode comprising:
generating a sound signal based at least in part on a detected sound;
verifying that the sound signal passes an input threshold;
transmitting the sound signal to a recognition server; and
transitioning the electronic device to a full power state upon receipt of a wake-up signal from the recognition server.

12. The method of claim 11, further comprising filtering the sound signal to generate a filtered sound signal.

13. The method of claim 12, wherein filtering the sound signal comprises one of: (i) modifying the amplitude of the sound signal; (ii) modifying the spectrum of the sound signal; (iii) modifying one or more frequencies of the sound signal; or (iv) performing spectral equalization of the sound signal.

14. The method of claim 11, wherein verifying that the sound signal passes an input threshold comprises comparing the sound signal to a sound signal template corresponding to a wake-up phrase.

15. The method of claim 11, wherein transitioning the electronic device to a full power state comprises waking up one or more processors associated with the electronic device from a stand-by state.

16. At least one computer-readable medium comprising computer-executable instructions that, when executed by one or more processors, executes a method comprising:
receiving a wake-up inquiry request from an electronic device in stand-by mode;
identifying a sound signal based at least in part on the wake-up inquiry request;
determining based at least in part on the sound signal that the sound signal is indicative of a wake-up phrase; and
sending a wake-up signal to the electronic device, responsive to determining that the sound signal is indicative of the wake-up phrase.

17. The computer-readable medium of claim 16, wherein determining that the sound signal is indicative of a wake-up phrase comprises at least one of: (i) spectral analysis of the sound signal; (ii) temporal analysis of the sound signal; (ii) analysis of audio parameters associated with the sound signal.

18. The computer-readable medium of claim 16, wherein the method further includes transmitting statistics associated with the electronic device to the electronic device.

19. The computer-readable medium of claim 16, wherein identifying a sound signal based at least in part on the wake-up inquiry request comprises parsing one or more data packets associated with the wake-up inquiry request.

20. A system, comprising:
at least one memory that stores computer-executable instructions;
at least one processor configured to access the at least one memory, wherein the at least one processor is configured to execute the computer-executable instructions to:
receive a wake-up inquiry request from an electronic device in stand-by mode;
identify a sound signal based at least in part on the wake-up inquiry request;
determine based at least in part on the sound signal that the sound signal is indicative of a wake-up phrase; and
transmit a wake-up signal to the electronic device, responsive to determining that the sound signal is indicative of the wake-up phrase.

21. The system of claim 20, wherein the at least one processor is further configured to log statistics related to the electronic device.

22. The system of claim 21, wherein the at least one processor is further configured to transmit statistics log to the electronic device.
